(19) United States
(12) Patent Application Publication
(10) Pub. No.: US 2003/0157216 A1
(43) Pub. Date: Aug. 21, 2003

(54) Accelerated oak extraction method

(76) Inventor: David Carl Plumb, Edina, MN (US)

Correspondence Address: DAVID CARL PLUMB, 6508 WILLOW WOOD RD., EDINA, MN, 55436, US

(21) Appl. No.: 10/360,983

(22) Filed: Feb. 8, 2003

Related U.S. Application Data
(60) Provisional application No. 60/355,229, filed on Feb. 8, 2002.

(51) Int. Cl. C12C 11/00

(52) U.S. Cl. 426/11

(57) ABSTRACT

Disclosed is a method for accelerating extraction of compounds from oak to flavor wine. Barrel staves are cut to increase surface area so that the longitudinal dimension is exposed. The longitudinal dimension has a liquid penetration rate eight times faster than the radial and tangential dimensions. Cross cutting to increase longitudinal surface area enables winemakers to use less oak for flavoring than with current barrel alternatives

### BACKGROUND OF THE INVENTION

This invention relates to the flavoring of wine with oak and more specifically to a process which decreases the cost of flavoring by accelerated extraction through longitudinal oak surfaces.

Oak flavor in wine is valued by consumers, yet barrel aging is expensive. Currently, 60 gallon barrels cost between $400-600 and are useful for only 3-5 fillings of wine. Barrels therefore add approximately $7 to the retail price of a bottle of wine.

These price parameters have changed with inflation but the underlying problem of barrel cost has yielded patented solutions for 70 years.

Most of the prior art has replicated the interior surface area of the barrel, always made with white oak, with pieces of oak placed in contact with wine. As known in the industry, these barrel alternatives have been configured to fit inside different types of containers, including bottles, used barrels, and stainless steel tanks.

Following are brief extracts from the “barrel alternative” prior art, describing the surface area concept.

Farrier U.S. Pat. No. 2,108,661: “a wooden liner . . . to provide a large surface area in contact with the liquor.”

Ramsay U.S. Pat. No. 2,114,009: “the aging means is in more intimate contact with the body of the liquor and . . . more surface is available for a certain quantity of liquor.”

Nilsson U.S. Pat. No. 2,203,229: “we may provide for a . . . greater surface upon the inside of the bottle by small changes of the arrangement (of oak).”

Boucher U.S. Pat. No. 3,842,723: “Accelerating aging . . . is accomplished by providing cuts or grooves or other suitable contours to increase the internal surface area to which whiskey is exposed.”

Herzfeld U.S. Pat. No. 3,942,423: “Another object is to furnish a means which together with a non-porous and non-gas-diffusing container allows the same surface contact on a per gallon basis between wood and liquid in said container as said liquor might have on a per gallon basis in any specified size aging and maturing cask.”

Hojnoski U.S. Pat. No. 4,558,639: “The present invention relates to an apparatus for the aging of wines in containers, such as oak barrels, in which the parameters of the oxidation and extraction reactions occurring during the aging of the wine are known as a function of the surface:volume relationship of the container and its novel insert.”

Sullivan U.S. Pat. No. 5,174,461: “The concept of the inventive barrel is basically to provide the same amount of wood surface area to wine volume as a standard sixty gallon . . . barrel, but utililizing less than twenty percent of the wood that is required in the conventional barrel.”

Sullivan U.S. Pat. No. 5,647,268: “Each sleeve section contains a plurality (e.g., ten) of small oak staves or similar flavor-imparting material.”

Vowles U.S. Pat. No. 5,537,913: “A further claim is to provide a container construction . . . in which it is possible to vary the ratio of surface area of wood in contact with a given volume of liquid up to or beyond that provided by a wooden barrel.”

Ecklein U.S. Pat. No. 6,378,419: “The number, height, and length of oak slabs to be used is dependent on the volume and geometry of the aging vessel and the type of wine to be aged.”

In all this prior art surface area is not differentiated as to type of surface area. This is not considered important or inventive because the wood used is sawn in the same way as with barrel staves (and all dimensional lumber), along the grain. Such sawing techniques have not been questioned because they are the most efficient in terms of sawing logs. When wood is sawn along the grain (rip sawn), the tangential and radial surface areas are exposed. With white oak these surface areas are extremely dense and impermeable, allowing liquid penetration of 1/64″ per month.

This is the key disadvantage of all this prior art: although barrels needn't be constructed and liquid can access all sides of the oak pieces, the penetration rate remains as slow as that of barrels. Cutting across the grain, as will be demonstrated below, increases the penetration rate by eight times, to ⅛″ per month, opening up new opportunities for savings not recognized from the conventional sawing perspective.

A few exceptions in the prior art to conventional, parallel grain sawing should be noted.

In two of Ramsay's embodiments (U.S. Pat. No. 2,114,009) rings or spirals are cut into the oak tube. But these are intended only to increase surface area: “It is the principal object of the present invention to . . . speed up the aging process in view of the fact that the aging means is in more intimate contact with the body of liquor and is constructed in such a manner that much more surface is available for a certain quantity of liquor.” Further, “the stick is preferably grooved or perforated to increase the surface thereof and this may be accomplished in many different ways without departing from the spirit of the invention.”

Grooves are also cut into Herzfeld's tube (U.S. Pat. No. 3,942,423). Again, “the purpose of said grooves is to increase the surface area of wood tube such that it becomes approximately equal on a per gallon basis to inside wood surface exposed to liquid of normally used wooden cask on a per gallon basis.”

Sullivan's Infusion Tube (U.S. Pat. No. 5,481,960) is an apparatus for holding oak pieces. However, in the course of describing its use he refers to the shape of the oak pieces which may be contained: “A quantity of pre-toasted cubes of French oak or similar flavor-imparting material are placed within the tubing central cavity. These wooden cubes or chips may be of any appropriate material size and degree of toasting. However, it has been found that French oak chips of a size approximately three-quarter inch by three-quarter inch by three-eights inch provide desirable flavoring characteristics for many applications.”

Although the cube option implies a cross cut of either ¾″ or ⅜″ (we don't know which), no mention is made of penetration rates or their significance and the cube size is merely suggested as a possible alternative for applications.

Significantly, Sullivan's Infusion Sleeve (U.S. Pat. No. 5,647,268), which uses traditionally sawn small oak staves, denigrates (in “Description of Prior Art”) the wood piece size in the Infusion Tube: “this structure is limited in its oak capacity, requiring periodic replacement of the oak with fresh oak, and otherwise may not be suitable for some applications.”

Gross U.S. Pat. No. 6,203,836 uses “cutting across the grain” language to describe how he ends up with wood pieces that are 0.3 to 0.45 cm thick. Again, there is no mention of extraction rate significance of the cross cutting and he goes on to say, “the size of the wood pieces is a matter of convenience and not crucial to the operation of our invention.” Gross instead relies on an elaborate set of soaking and heating procedures to reduce extraction time.

Howell U.S. Pat. No. 5,102,675 uses chips that have some % of cross cut surface area but the method of production renders this % uncertain: “After drying, the wood was cut into 4” square blocks and passed through a hammermill with chains and cutting head to obtain chips. These ranged in size from 0.1 to 4 mm in width, 0.1 to 4 mm in thickness, and 0.1 to 4 mm in length.” Oak chips are not only unpredictable in surface area size and orientation, but the hammermill chipping process is considered inferior by winemakers to sawing staves for producing desirable oak flavor. Howell's invention attempts to improve the flavor of chips through leaching in an ethanol solution.

### SUMMARY OF THE INVENTION

Primarily because the prior art uses conventional sawmill cutting techniques to create or increase surface area, it does not describe how going (cutting) against the grain, literally, can increase wine penetration and oak extraction rates. We have discovered that the longitudinal surfaces created by cross cutting white oak are eight times more permeable (porous) than tangential and radial surfaces created by conventional cutting. This increase in penetration rate lowers cost and increases flexibility for winemakers using oak to flavor wine.

### Object of the Invention

Increase penetration rate of white oak pieces used to flavor wine.

### Advantages of the Invention

1. The cost of oak flavoring is lowered by exposing oak surfaces eight times more permeable than conventional surfaces, thereby cutting waste and reducing oak requirements;

2. Increased oak permeability allows for a wide range of extraction time products, determined by the formula, ⅛″ thickness=one month extraction;

3. Smooth and efficient oak integration results for winemakers who can match planned oak/wine contact times with our extraction time options;

4. Oak contamination and flavor taint is eliminated by offering extraction-timed single use products that are not exposed to micro-organisms, as happens with re-use of wetted oak;

5. Oak requirements can be calculated precisely with “volume extracted”specifications, translatable into barrel equivalents;

6. The versatile and precise cross-cut products are easily used in all wine containers.

Clarification of these advantages will become apparent from a consideration of the ensuing descriptions and drawings.

### DESCRIPTION OF THE SEVERAL VIEWS OF THE DRAWINGS

FIG. 1 is a perspective of a squared log with annual growth rings 10 shown on the longitudinal face 11. Included in FIG. 1 is an outline of a rectangular piece of lumber or, for cooperage use use, stave 12 as it would be sawed from the log. A stave section 13 is also shown with longitudinal face 11, radial face 14 and tangential face 15.

FIG. 2 shows a closer perspective of the stave section 13 with three faces: longitudinal 11, radial 14 and tangential 15. FIG. 2 also shows ripped stave strips 16a, 16b, 16c, cut along the radial and tangential axes and perpendicular to the longitudinal axis.

FIG. 3 shows a perspective of said stave section 13, with longitudinal 11, radial 14, and tangential 15 faces. Here, however, cross cuts have been made along the longitudinal axis and perpendicular to the radial and tangential axes, yielding sections 17a-17j.

FIG. 4 shows a closer perspective of ripped strip 16a from FIG. 2, with three faces: longitudinal 11, radial 14, and tangential 15. Also shown, on the longitudinal face 11 are marks representing wine penetration 18 from the tangential faces 15 of stave strip 16a.

FIG. 5 shows the surface face of rectangular cros-cut section 17a, rotated 90 degrees, from FIG. 3. With the rotation the frontal view of the cross-cut section 17a is now the tangential face 15. The longitudinal face 11 is now on the left and the radial face remains on top. Marks of wine penetration 19 are shown coming from the longitudinal faces of cross-cut section 17a.

FIG. 6 shows a perspective of a channeled stave section 20 with three faces: longitudinal 11, radial 14, and tangential 15. Here, cross cuts 21 have been made to stave section 13 in FIGS. 1-3, but not through the piece, resulting in a rod 22 and a series of rectangular fins 22 attached to the rod 21.

FIG. 7 shows a perspective of said stave section 13, with longitudinal 11, radial 14, and tangential 15 faces. Here, however, cross cuts have been all the way through the longitudinal axis and perpendicular to the radial and tangential axes, yielding slices 23a-23j.

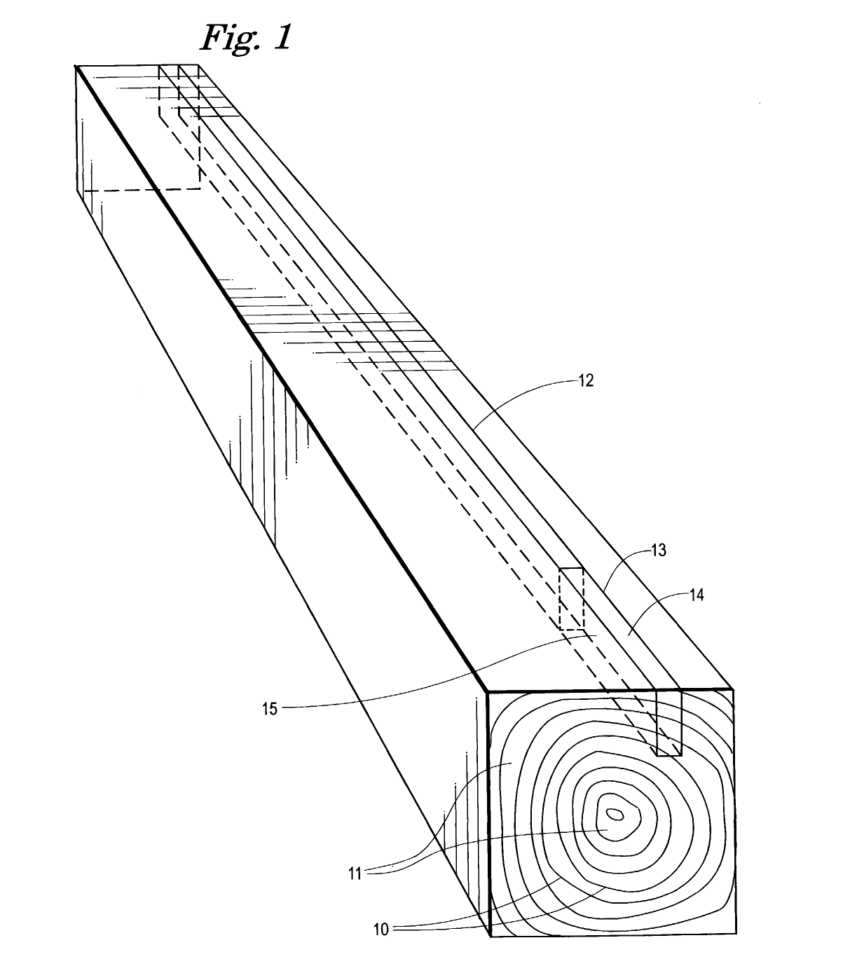

### DESCRIPTION OF THE INVENTION

Using white oak staves we cross cut slats (⅛″ blade thickness) across the length with various spacing. The staves then contain a multiple of their original surface area on the longitudinal axis, which can be penetrated by wine at a rate eight times that of the original surface area axes, tangential and radial. The unconventional, against the grain cross cutting lowers cost and increases flexibility for winemakers using oak to flavor wine in a variety of containers.

This method of cross cutting slats to increase the ongitudinal surface area differs from previous and conventional methods which use traditional sawing along (parallel to) the grain. The old method increases surface area along the tangential and radial axes.

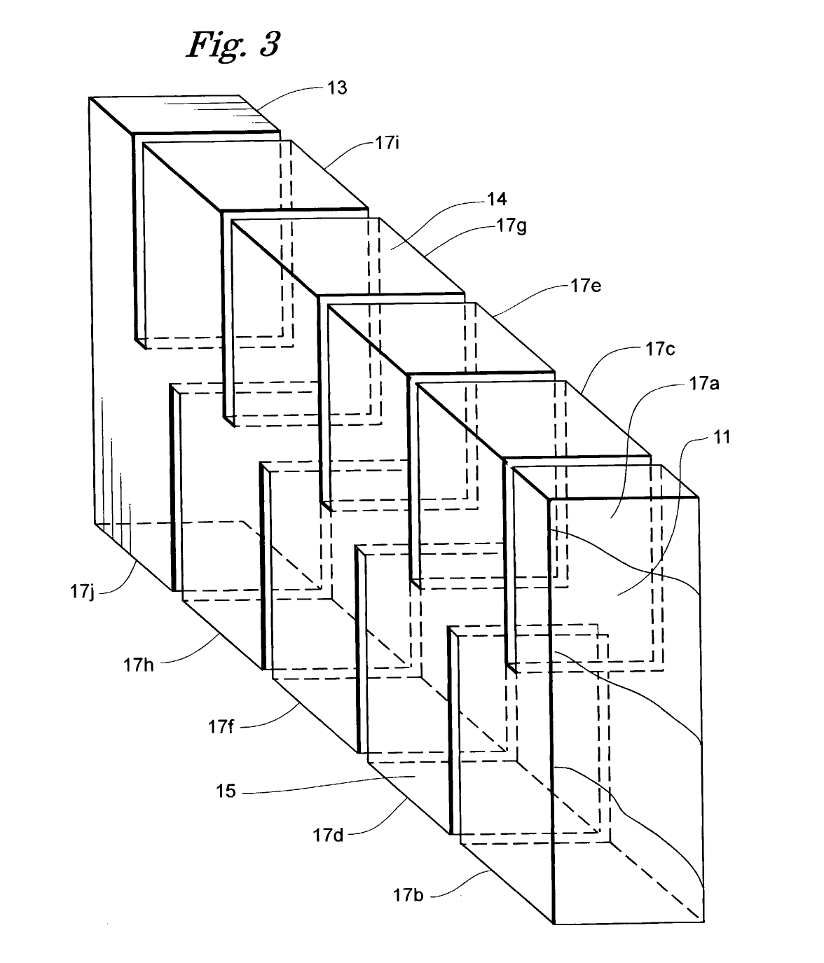

The best mode of carrying out this invention is to make cuts on the top and bottom radial surfaces of barrel staves. These cuts can be from ⅜″ up to 3″ apart, depending on the extraction time required. The cuts from either side should be off-set (staggered) so they can come close to the center of the stave without meeting, to preserve the strength of the stave. So, if the gap between cuts was ¾″, the cut on the bottom side would be offset ⅜″ from the cut on the topside. The centers for cuts in this example would be ¾″ for both radial sides. FIG. 3 illustrates this principle.

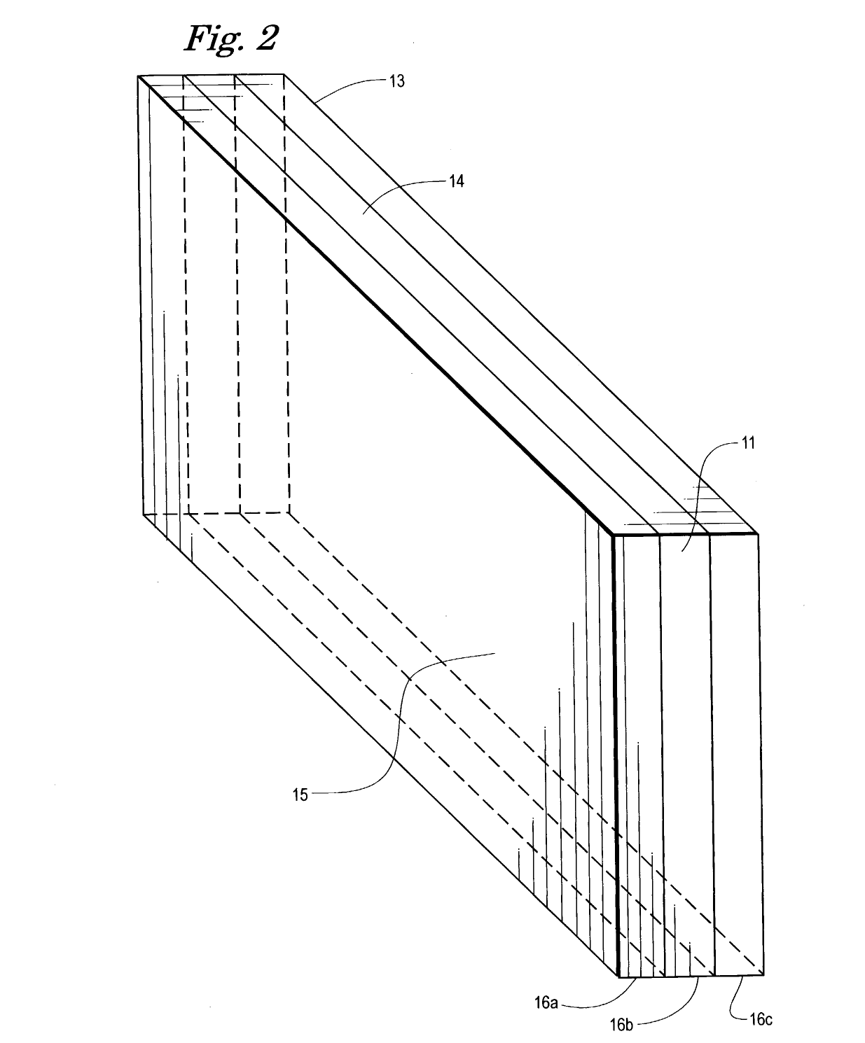

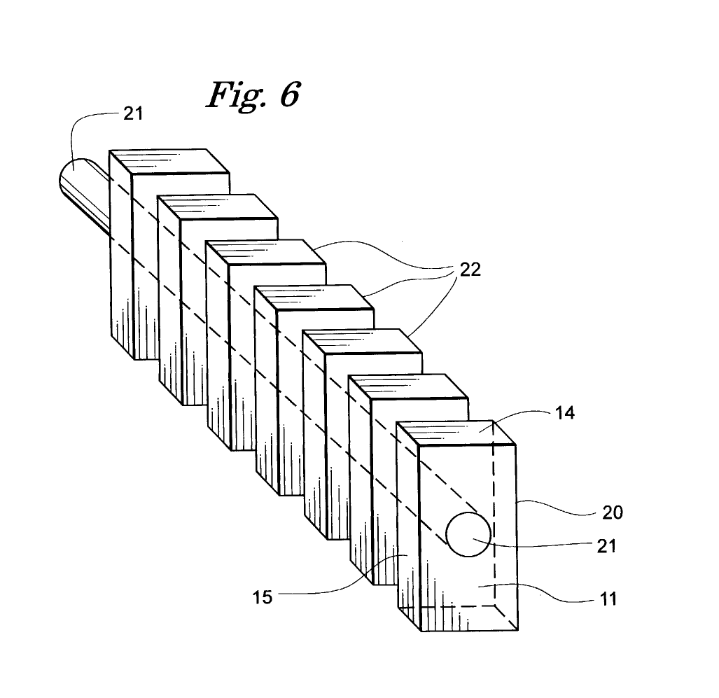

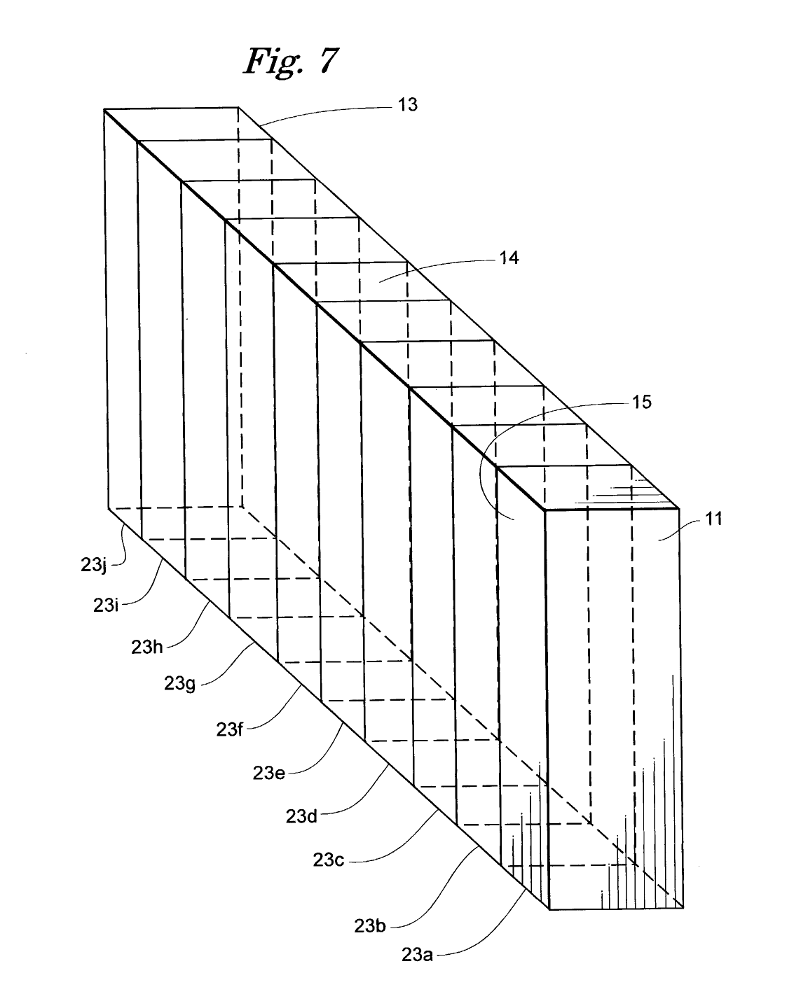

In operation, ripped stave strips 16a-c (FIG. 2), cross-cut stave sections 17a-j (FIG. 3, channeled stave sections 20 (FIG. 6, and stave slices 23a-j (FIG. 7) are placed in contact with wine in tanks or barrels to impart oak flavors to the wine during fermentation and aging.

When in contact, wine penetrates oak and extracts soluble chemical compounds (flavors) from the wood. The penetration/extraction rate by volume varies depending on two factors: amount of surface area and type of surface area.

Type of surface area has not been recognized by prior art. So the manufacturing process for oak alternatives has been to rip (along radial and tangential axes) oak staves 12 because this is the traditional and least expensive sawing method for dimensional lumber, Current sawed oak alternatives therefore are all derivatives of ripped stave strips 16a, 16b, and 16c in FIG. 2.

The invention discussed here, the cross-cut stave method (FIG. 3 and embodiments, channeled stave section (FIG. 6) and stave slices (FIG. 7) are based on the heretofore unrecognized benefit of longitudinal face exposure: wine penetration/extraction is eight times quicker through the longitudinal face 11 than through radial 14 and tangential 15 surfaces.

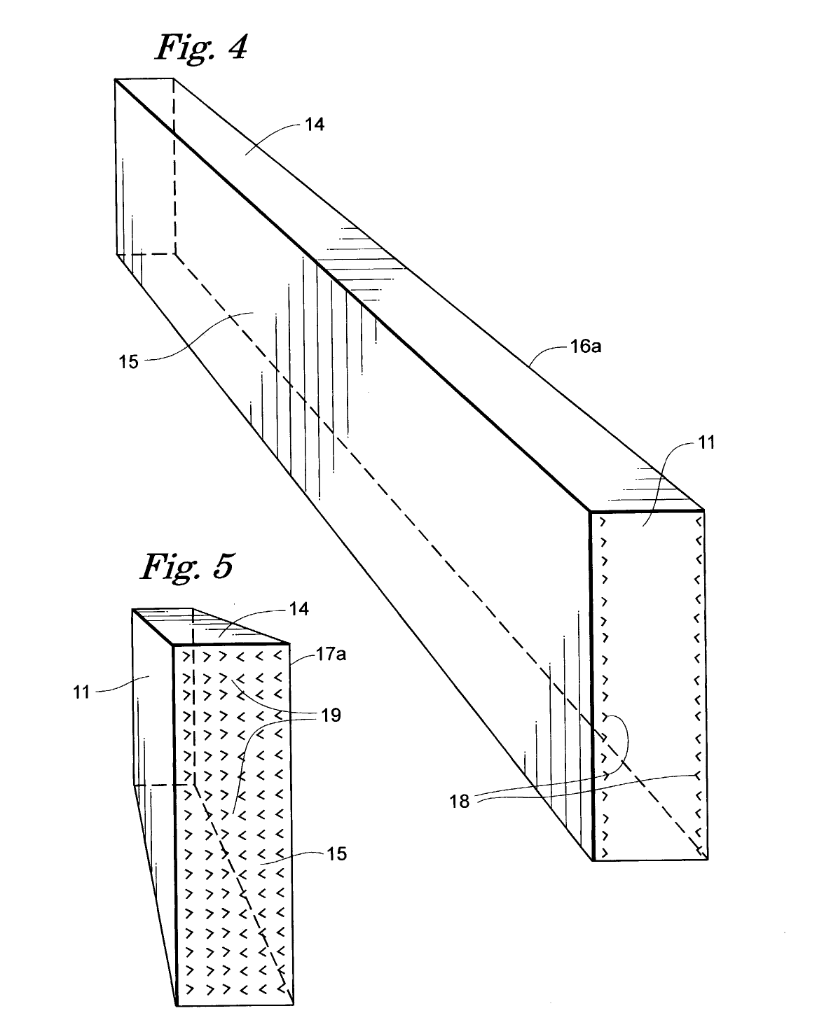

This benefit is illustrated in FIGS. 4 and 5, which show oak pieces after being in contact with wine. The thickness of the two pieces is the same. However, the rate of wine penetration/chemical extraction is different at the ratio of 1:8. The slow rate of penetration/extraction for the oak strip 16a in FIG. 4 is caused by low permeability in the tangential faces 15. The fast rate of penetration/extraction in the cross cut stave (FIG. 5) is due to the high permeability in the longitudinal face 11.

The embodiments in FIGS. 6 and 7 have the same cut orientation and the same accelerated extraction benefits.

What I claim as my invention is:

1. A method for accelerating the extraction of soluble chemicals in oak for flavoring wine by:
a) cutting oak across the grain,
b) increasing the surface area of longitudinal faces rather than radial and tangential faces,
c) increasing the permeability and penetrability of said oak,
whereby wine in contact with said pieces will more quickly extract flavoring chemicals.
